(19) United States
(12) Patent Application Publication
(10) Pub. No.: US 2013/0300317 A1
(43) Pub. Date: Nov. 14, 2013

(54) LIGHT BULB

(71) Applicant: Shu-Ping Liu, Taipei (TW)

(72) Inventor: Shu-Ping Liu, Taipei (TW)

(73) Assignee: DIODE-ON OPTOELECTRONICS LIMITED, Taichung City (TW)

(21) Appl. No.: 13/555,268

(22) Filed: Jul. 23, 2012

(30) Foreign Application Priority Data
May 10, 2012 (TW) 101208847

(51) Int. Cl. F21V 21/00

(52) U.S. Cl. 315/312

(57) ABSTRACT

A light bulb includes a bulb base, a light holder, a plurality of light emitting elements, and a bulb shell. The bulb base has a connection part and an engaging part disposed opposite to each other. The light holder includes a surrounding wall connected to the bulb base at the engaging part, and an end wall connected to the surrounding wall. The light emitting elements are disposed on the surrounding wall and the end wall and are connected electrically to the bulb base. The bulb shell includes a light-transmissive shell body that engages the engaging part of the bulb base, and has a receiving space defined by the shell body and into which the light holder extends.

### BACKGROUND OF THE INVENTION

1. Field of the Invention

The invention relates to a light bulb, and more particularly to an LED light bulb capable of wide-angle illumination.

2. Description of the Related Art

Referring to FIG. 1 and FIG. 2, a conventional LED light bulb 1 includes a bulb base 11, a bulb shell 12, and a plurality of light emitting diode (LED) elements 13. The bulb base 11 includes a light holder 111 formed on an end surface thereof and an external thread 112 formed around the light holder 111. The bulb shell 12 is shaped as a half-sphere, and includes an internal thread 121 to engage the external thread 112. The LED elements 13 are mounted on the light holder 111.

Use of the LEDs may raise lighting efficiency to thereby save energy and prolong the service life, but due to the limited light emitting angle of the LED (generally around 120 degrees), the range of illumination of the LED light bulb 1 is smaller than that of an incandescent lamp.

### SUMMARY OF THE INVENTION

Therefore, an object of the present invention is to provide an LED light bulb capable of wide-angle illumination compared to a conventional LED light bulb.

According to the present invention, a light bulb comprises:

a bulb base including a connection part and an engaging part disposed opposite to each other along an axis, the connection part being configured for electrical connection with an electrical power source;

a light holder including a surrounding wall which has a first peripheral end connected to the bulb base at the engaging part, and a second peripheral end opposite to the first peripheral end along the axis, the light holder further including an end wall connected to the second peripheral end of the surrounding wall;

a plurality of light emitting elements disposed on the surrounding wall and the end wall and connected electrically to the bulb base; and

a bulb shell including a light-transmissive shell body that engages the engaging part of the bulb base, and having a receiving space defined by the shell body and into which the light holder extends.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded perspective view of a conventional LED light bulb;

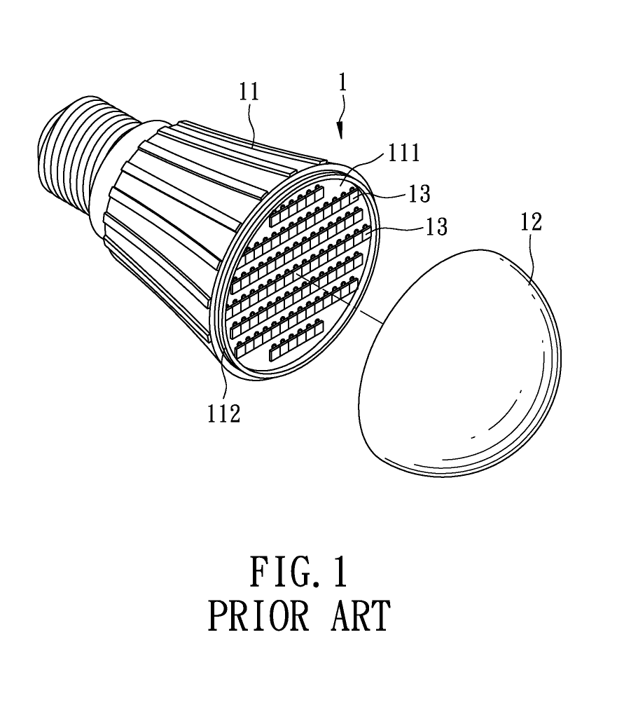

FIG. 2 is a partly sectional view of the conventional LED light bulb;

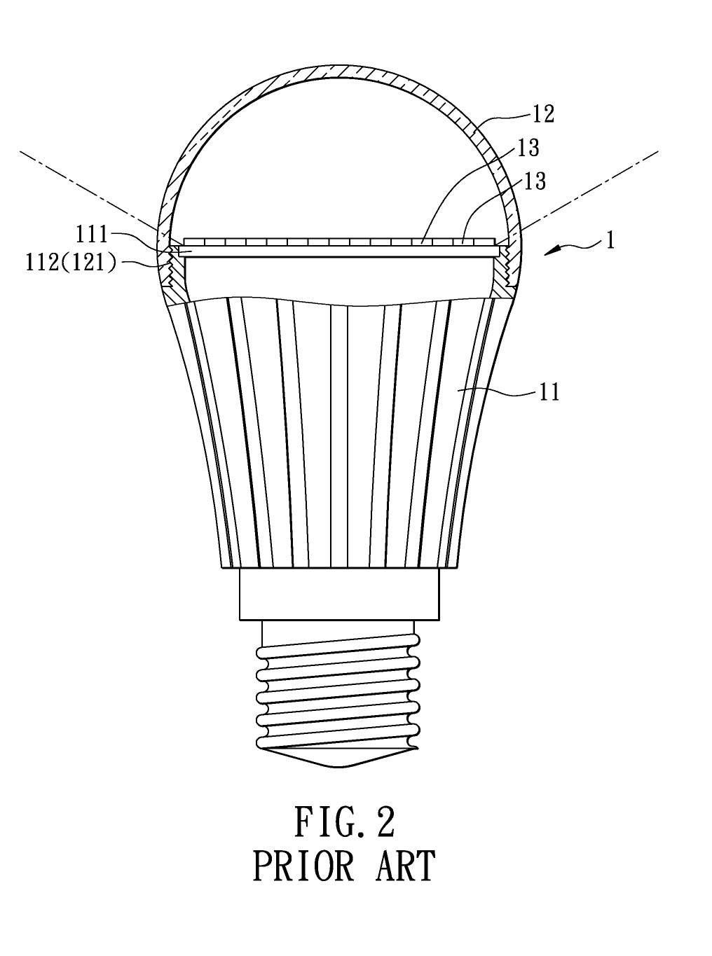

FIG. 3 is an exploded perspective view showing a preferred embodiment of the light bulb according to the present invention and an adapter; and

FIG. 4 is a partly sectional view of the preferred embodiment.

### DETAILED DESCRIPTION OF THE PREFERRED EMBODIMENT

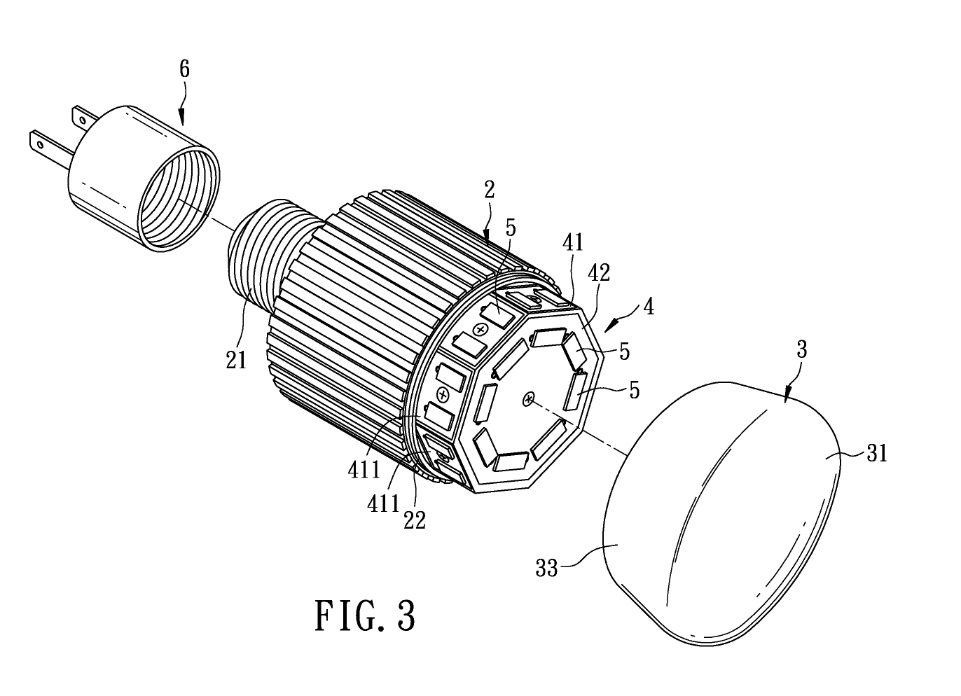

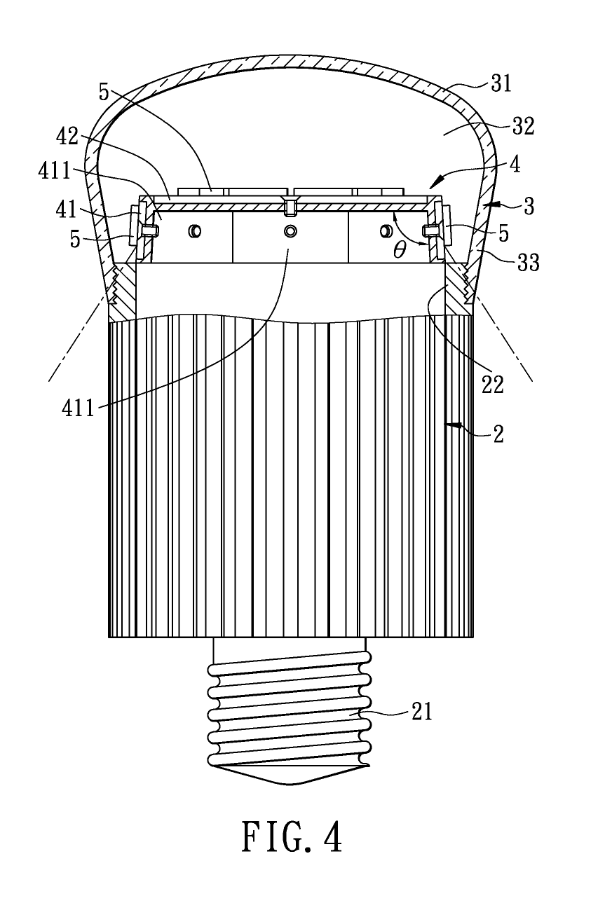

Referring to FIG. 3 and FIG. 4, the preferred embodiment of the light bulb according to the present invention comprises a bulb base 2, a bulb shell 3, a light holder 4, and a plurality of light emitting elements 5.

The bulb base 2 includes a connection part 21 and an engaging part 22 disposed opposite to each other along an axis. The connection part 21 is configured for electrical connection with an electrical power source (not shown). Preferably, the connection part 21 is configured for connection to an adapter 6 so as to be pluggable into a common power outlet.

The light holder 4 includes a surrounding wall 41 which has a first peripheral end connected to the bulb base 2 at the engaging part 22, and a second peripheral end opposite to the first peripheral end along the axis. The light holder 4 further includes an end wall 42 connected to the second peripheral end of the surrounding wall 41. The surrounding wall 41 and the end wall 42 form an angle θ therebetween. The angle θ may range from 0 degree to 180 degrees.

In this embodiment, the surrounding wall 41 has eight planar surfaces 411 that are interconnected to form an octagon. In other embodiments, the number of the planar surfaces 411 may be 2, 3, 4, 5, 6, 7, or over 9, and the surrounding surface 41 may be formed with a plurality of curved surfaces connected to each other.

In this embodiment, the end wall 42 is a flat surface, but it may be a convex curved surface or a concave curved surface in other embodiments.

The light emitting elements 5 are disposed on the surrounding wall 41 and the end wall 42 and are connected electrically to the bulb base 2. The light emitting elements 5 are light emitting diodes in this embodiment.

It should be noted that, in this embodiment, the light emitting elements 5 are LEDs with 120 degree light emitting angle. Therefore, a better lighting effect may be achieved when the angle θ ranges from 90 degrees to 135 degrees. In this embodiment, the angle θ is 95 degrees.

The bulb shell 3 includes a light-transmissive shell body 31 that engages the engaging part 22 of the bulb base 2, and has a receiving space 32 defined by the shell body 31 and into which the light holder 4 extends. In this embodiment, the shell body 31 is shaped as a mushroom, but may be shaped as a pear or a half-sphere in other embodiments. The shell body 31 engages the engaging part 22 by engagement of an internal thread formed on an end thereof and an external thread formed on of the engaging part 22 of the bulb base 2. It should be noted that the shell body 31 and the engaging part 22 of the bulb base 2 may be engaged by a latch mechanism. In this embodiment, the shell body 31 has a frustoconical portion 33 connected to and diverging along the axis away from the engaging part 22.

To sum up, the present invention uses the LEDs as light emitting elements so as to achieve high lighting efficiency, low energy consumption, and long service life. Moreover, by use of the LEDs disposed on the surrounding wall 41, which forms an angle with the end wall 42, light may pass through the frustoconical portion 33 of the bulb shell 3, so as to achieve wide-angle illumination.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A light bulb comprising:
a bulb base including a connection part and an engaging part disposed opposite to each other along an axis, said connection part being configured for electrical connection with an electrical power source;
a light holder including a surrounding wall which has a first peripheral end connected to said bulb base at said engaging part, and a second peripheral end opposite to said first peripheral end along the axis, said light holder further including an end wall connected to said second peripheral end of said surrounding wall;
a plurality of light emitting elements disposed on said surrounding wall and said end wall and connected electrically to said bulb base; and
a bulb shell including a light-transmissive shell body that engages said engaging part of said bulb base, and having a receiving space defined by said shell body and into which said light holder extends.

2. The light bulb as claimed in claim 1, wherein said surrounding wall of said light holder has at least two planar surfaces on which a portion of said light emitting elements is disposed.

3. The light bulb as claimed in claim 2, wherein said surrounding wall of said light holder has eight of said planar surfaces that are interconnected to form an octagon.

4. The light bulb as claimed in claim 1, wherein said surrounding wall and said end wall form an angle that ranges from 90 degrees to 135 degrees.

5. The light bulb as claimed in claim 1, wherein said shell body of said bulb shell has a frustoconical portion connected to and diverging along the axis away from said engaging part.

6. The light bulb as claimed in claim 1, wherein said light emitting elements are light emitting diodes.
